(19) United States
(12) Patent Application Publication
(10) Pub. No.: US 2023/0229794 A1
(43) Pub. Date: Jul. 20, 2023

(54) METHOD AND SYSTEM FOR OPERATING A SAFETY-CRITICAL DEVICE VIA A NON-SECURE NETWORK AND FOR PROVIDING RELIABLE DISENGAGEMENT OF OPERATIONS OF THE DEVICE

(71) Applicant: Kongsberg Defence & Aerospace AS, Kongsberg (NO)

(72) Inventors: Pal Longva Hellum, Blommenholm (NO); Lars Egil Bjorset, Kongsberg (NO)

(21) Appl. No.: 17/577,068

(22) Filed: Jan. 17, 2022

(51) Int. Cl. G06F 21/60; H04L 67/01

(52) U.S. Cl. CPC G06F 21/606; H04L 67/42

(57) ABSTRACT

A system and method for operating, at a near location, a safety-critical device 260 located at a remote location. The system comprises a first control panel interface 200 and at least one operating input device 220 at a near location, adapted for transmitting control signals to the safety-critical device 260 at a remote location. The first control panel interface 200 comprises hardware barrier communication means 206 and at least a first and a second hardware safety barrier 202, 204, each with safety barrier interfaces connected to the at least one operating input device 220 and to the hardware barrier communication means 206 for communication through the non-secure network 240. The system further comprises a second control panel interface 250, connected to the safety-critical device at the remote location, adapted for receiving control signals from the first control panel interface 210 via a secure communication tunnel 242. The second control panel interface 250 comprises hardware barrier communication means 256 and at least a first and a second hardware safety barrier 252, 254, each with safety barrier interfaces connected to the hardware barrier communication means 256 for communication through the non-secure network 240. A switch 215 is connected to the first and second hardware safety barriers 202, 204 of the first control panel interface 200, controlling Hi- and Lo-signal inputs on the hardware safety barriers, such that a Hi-signal is input on the first hardware safety barrier 202 and a Lo-signal is input on the second hardware safety barrier 204 and vice versa for respectively enabling and disengaging operation of the safety-critical device 260. The safety-critical device 260 is activated when both hardware barriers 252, 254 are activated and the switch is in an enabled state.

### FIELD OF THE INVENTION

The present invention relates to a method and system for operating a safety-critical device over a non-secure communication network, and for providing reliable disengagement of ongoing operations of the device.

### BACKGROUND OF THE INVENTION

Secure operations of safety-critical devices are vital. For remote controlled operations several measures are standardized and required to operate safety-critical devices. This is especially the case in the defense industry where malfunctioning weapons may have fatal consequences. This industry is moving towards standardized platforms and infrastructures for safe operation of safety-critical devices. In these platforms all systems are required to interoperate over packet-based networks. The operator positions become multipurpose operator positions shared between several systems. The interface between the system and the operator positions thus changes.

The applicant has previously developed a solution where safety-critical operations at a remote location are controlled from a local location via Control Panel Interfaces (CPI) at each location. The solution is described in U.S. Pat. No. 10,063,552 B2, which is hereby included as a reference.

The described solution provides a secure way of enabling and controlling, at a near location, operations of a safety-critical device located at a remote location.

The basic principle of the solution is illustrated in FIG. 1. The safety-critical device 180 may as an example be a weapon firing circuitry or a weapon movement circuitry at a remote location which are operated from a near location.

The upper part of FIG. 1 represents the near location and the lower part of the figure represents the remote location.

The system comprises a first operating input device 110 to be operated at the near location by an operator providing a first barrier control signal 112. The system further comprises a second operating input device 120 to be operated at the near location by an operator, providing a second barrier control signal 122.

The operating input device 110, 120 may as an example be a weapon fire control device or a weapon movement control device.

The first 110 and second 120 operating input devices may be arranged to be operated by the same operator or by different operators.

The first and second barrier control signals 112, 122 are communicatively connected to a near end of a secure communication tunnel through a non-secure communication network 140.

A remote end of the secure communication tunnel is communicatively connected to an activating input 152 of a first barrier circuit 150, and to an activating input 162 of a second barrier circuit 160.

The first 150 and second 160 barrier circuits are configured to enable operation of the safety-critical device 180 when both the first 150 and second 160 barrier circuits are activated.

Advantageously, separate hardware circuits are used for implementing the first 150 and second 160 barrier circuits.

The system may further be configured for operating a plurality of safety-critical devices, located at the remote location. The system may then comprise a first multiplexer which multiplexes a plurality of first barrier control signals onto the secure communication tunnel through the non-secure communication network 140. The system may further comprise a second multiplexer, multiplexing a plurality of second barrier control signals onto the secure communication tunnel through the non-secure communication network. The first barrier circuit 150 comprises a first demultiplexer, and the second barrier circuit 160 comprises a second demultiplexer. More details of these features are described in the reference U.S. Pat. No. 10,063,552 B2.

The non-secure communication network 140 may be a packet-based communication network, such as an Internet Protocol (IP) network. The secure communication tunnel may be an IPsec tunnel for the first barrier control signals and the second barrier control signals. The IPsec tunnel may be configured in an integrity only mode, where IPsec receivers authenticate barrier control signals sent by IPsec transmitters to ensure that the data has not been altered during transmission. The barrier circuits may further be configured with a configurable or fixed IP addressing scheme. The configurable scheme may by a dynamic scheme. By using fixed IP addressing higher safety is achieved.

The communication through the secure communication tunnel may employ a protocol which includes timestamping of data. Such aspects are described in the reference U.S. Pat. No. 10,063,552 B2.

In a particular aspect, an operating input device may include a video session information device, and the safety-critical device may be a video confirmation device. In this aspect, the system may further comprise a video distribution device. The video distributing device is arranged to provide a video signal which is transferred through the non-secure communication network and displayed on a display screen at the near end. Further, the video session information device may be configured to derive video session information from the video signal and transfer the video session information through the secure communication tunnel. Also. the video confirmation device may be configured to confirm the authenticity of the video signal transferred through the non-secure communication network. These aspects of a video session information device have been explained in closer detail in reference U.S. Pat. No. 10,063,552 B2.

When distributing data requiring high bandwidth, such as video, stable and high-quality radio communication is not guaranteed, and signal transmission will have a relatively short range compared to radio communication with low bandwidth.

Signal transmission for performing safety-critical operations such as controlling of movements and firing of a weapon station at a remote location will not require high bandwidth. This can thus be performed through each HW barrier while video can be transferred via different channels.

Authorization to proceed (ATP) in relation to weapon systems using Artificial Intelligence (AI) is linked to ethical principles, and the possibility that a person can monitor and deactivate misbehaving AI systems is an absolute requirement.

The Department of Defense (DoD) in the United States has recommended a set of guiding principles for operating weapon systems with different levels of autonomy. One of these principles is that the system must be governable i.e. that the design of AI capabilities shall fulfill their intended functions while possessing the ability to detect and avoid unintended consequences, and the ability to disengage or deactivate deployed systems that demonstrate unintended behavior.

The operational levels are defined as:
1. Teleoperated, man-in-the loop where a safety critical device is controlled from a remote operator position.
2. Assisted, man-in-the loop where a safety critical device is controlled from a remote operator position. The operator is assisted by support functionality to enhance the operation.
3. Semi-autonomous target acquisition (TA), man-in-the loop, where a safety critical device is performing autonomous supervision and Target Acquisition (TA), The safety critical device prepares the system for the human operator inspection and/or Target Engagement (TE).
4. Semi-autonomous TE, man-on-the loop, where a safety critical device is performing autonomous supervision and target acquisition. Target engagement is authorized from the operator position based on information provided by the safety critical device.
5. Pre-Authorized TE, supervised man-off-the loop, where a safety critical device is authorized for a limited engagement, while retaining human supervision. This can for instance be defined by a class of objects in a predefined area. The safety critical device is performing autonomous supervision, target acquisition and within the defined bounds, engagement.

For scenarios involving robotic combat vehicles, authorization to proceed is given by one or more operators. It is vital that there is fail-safe way of stopping initiated operations. This is especially the case for scenarios, where the initiated operations are performed by Artificial Intelligence (AI) capabilities of a device at a remote location.

There is thus a need for a solution which may be used for systems to transport safety barriers and signaling over IP/Ethernet networks and thus to provide an Authorization to proceed (ATP), i.e. to disengage safety-critical devices utilizing available radios.

To meet the recommended principles, a device should be fieldable and it should have the following characteristics:
It should provide a generalized mechanism for transport of safety barrier signals over a network.
It should provide transparent signaling capacity for third party signaling.
It should provide managed connectivity between the safety clients and the safety server through Multi-Client and Multi-Server functionality.
It should provide server auto-discovery protocol to simplify the use of the solution.
It should have a small physical footprint.
It must provide a viable path to safety approval, preferable using other safety approved solutions like the Control Panel Interface (CPI).

A fieldable solution should further have the following characteristics:
It should provide compatibility with the operational solutions on Unmanned Ground Vehicles (UGV), e.g. the Interoperability Profile (IOP) of the UGV or the CPI, which is safety approved, so as not to introduce yet another solution to be approved that would increase the footprint of the solution.
It must provide a viable path to safety approval, preferable by using other fielded and safety approved solutions like the CPI.
It should not be bandwidth consuming. The ATP function should be fieldable on robust long-range radios with good coverage to enable operation of the AI/autonomy functionality on the vehicle, without a high bandwidth radio, which is short range and less robust.
It should allow for independent routing to separate operator positions to enable centralized ATP operators. i.e. Multi-Client and Multi-Server functionality.
It should be media agnostic to enable the ATP to run over copper, fiber and radio.

For weapon station installations, it would be beneficial to enable the use of the ATP solutions in cases like UGVs as explained above but also in stationary installations where:
The operator position and the position providing the authorization to proceed are physically separated.
The weapon station is remote from the operator providing the authorization to proceed.

Examples of the above are ships with weapon enabled from the bridge or a base camp with weapon enabled from a supervisor position. For these cases the ATP function is today generally hardwired. With the present invention, it can be networked to enable larger distances with more robust installations, e.g. without using dedicated copper wiring for communication.

The present invention can be applied for all the above listed scenarios, and to different kinds of safety-critical devices safely controlled via a non-secure network.

The solution is called an E-stop and is considered to be similar to ATP with regards to safety but is operating differently. In the ATP solution, a user enables an operation, and in the E-stop solution a user disables an operation.

The solution provides a generalized solution with a safe and secure way of disengaging or deactivating deployed systems.

The solution provides a method and system which may utilize aspects of already existing, hard-wired solutions, fulfil relevant safety requirements, provide a secure, tamper proof and supervised connection, make use of standard protocols and networking elements, and which can be dynamically changed according to needs.

The solution can be applied to available radio communication devices to provide sufficient range to provide a fieldable solution for safety-critical devices operated according to the principle above.

### Short Description of the Invention

The invention relates to a method and system for operating a safety-critical device over a non-secure communication network, and for providing reliable disengagement of ongoing operations of the device.

The system comprises:
a first control panel interface, at a near location, adapted for transmitting control signals to the safety-critical device at a remote location, the first control panel interface comprises hardware barrier communication means and at least a first and a second hardware safety barrier, each with safety barrier interfaces connected to at least one operating input device and to the communication means for communication through the non-secure network,
a second control panel interface, connected to the safety-critical device, adapted for receiving control signals from the first control panel interface via a secure communication tunnel, the second control panel interface comprises hardware barrier communication means and at least a first and a second hardware safety barrier, each with safety barrier interfaces connected to the hardware barrier communication means for communication through the non-secure network, were the safety-critical device is activated when both hardware barriers are activated,

The system further comprises:
a switch, connected to the first and second hardware safety barriers of the first control panel interface, controlling Hi- and Lo-signal inputs on the hardware safety barriers, such that a Hi-signal is input on the first hardware safety barrier and a Lo-signal is input on the second hardware safety barrier and vice versa for respectively enabling and disengaging operation of the safety-critical device.

In one embodiment, the system further comprises a light source connected to the first and the second hardware safety barriers of the first control panel for indicating status of the safety-critical device. This is preferably one or more LEDs capable of displaying different colors, where for instance green indicates that the safety critical device is enabled, while red indicated that the safety-critical device is disabled.

In one embodiment, the system further comprises a software safety barrier with transparent signaling to and from the first and second control panels interfaces. Transparent signaling channels may provide TOP signaling (JAUS messages) for RCV/UGV mobility solutions or other protocols.

In one embodiment of the system, the first and second control panels interfaces comprise identical hardware, where the first control panel interface is operated as a client, while the second control panel interface is operated as a server. How they are operating is controlled by SW running on each control panel interface.

Further features of the system are defined in the claims.

The invention is further defined by a method comprises:
providing, at a near location, a first control panel interface for transmitting control signals the safety-critical device at a remote location, the first control panel interface comprises hardware barrier communication means and at least a first and a second hardware safety barrier, each with safety barrier interfaces connected to at least one operating input device and to the hardware barrier communication means for communicating through the non-secure network,
providing, at the remote location and connected to the safety-critical device, a second control panel interface adapted for receiving control signals from the first control panel interface via a secure communication tunnel, the second control panel interface comprises hardware barrier communication means and at least a first and a second hardware safety barrier, each with safety barrier interfaces connected to the hardware barrier communication means for communication through the non-secure network,
establishing communication between the first and second control panel interfaces via said first and second hardware safety barriers and the communication means of the first and second control panel interfaces,
connecting a switch to the safety barrier interfaces of the first and second hardware safety barriers of the first control panel interface and transmitting a Hi-signal on the first hardware safety barrier and a Lo-signal on the second hardware safety barrier when the state of the switch is enabled, and transmitting a Lo-signal on the first hardware safety barrier and a Hi-signal on the second hardware safety barrier when the state of the switch is disabled,
activating the safety-critical device when both hardware barriers of the second control panel interface are activated and the switch connected to the first control panel interface is enabled,
continuously monitoring the Hi- and Lo-signals received on the first and second hardware safety barriers of the second control panel interface, and continuously returning the received Hi- and Lo-signals to the first control panel interface via the first and second hardware safety barriers of the second control panel interface,
disengaging the safety-critical device if the switch is in a disabled state.

In one embodiment, the method comprises connecting a light source to the first and the second hardware safety barriers of the first control panel interface for indicating status of the safety-critical device.

In one embodiment of the method, the state of the switch is continuously signaled from the first control panel interface to the second control panel interface and it is continuously verified that the state of the switch corresponds to the Hi- and Lo-signals received on the second hardware safety barriers of the second control panel interface.

In one embodiment of the method, the safety-critical device is disabled when communication between the first and second control panel interfaces is lost, thereby returning the safety-critical device to a default safe state.

Further features of the method are defined in the claims.

### BRIEF DESCRIPTION OF THE DRAWINGS

FIG. 1 is a schematic block diagram illustrating the different modules comprised in a system according to prior art.

FIG. 2 is a schematic block diagram illustrating a system according to the invention.

FIG. 3 illustrates a first solution according to the invention with a man-in-the-loop according to operational levels 1 to 3.

FIG. 4 illustrates a second solution according to the invention with a man-on-the-loop and man-off-the-loop according to operational levels 4 and 5.

FIG. 5 illustrates a third solution according to the invention with man-in-the-loop, man-on-the-loop and man-off-the-loop according to operational levels 1 to 5.

FIG. 6 illustrates first and second control panel interfaces operating with client and server services.

FIG. 7 illustrates the main interfaces of the invention and the implemented ATP (E-stop).

FIG. 8 illustrates the implemented ATP (E-stop) used with a diagnostic information path.

FIG. 9 shows a block diagram of the first control panel interface, operating as a client.

FIG. 10 shows block diagram of the second control panel interface, operating as a server.

### DETAILED DESCRIPTION OF THE INVENTION

As mentioned in the background section above, there is a need for a solution which may be used for systems to transport safety barriers and signaling over IP/Ethernet networks and to provide an “Authorization to proceed” (ATP) for disengaging safety-critical devices utilizing available radios.

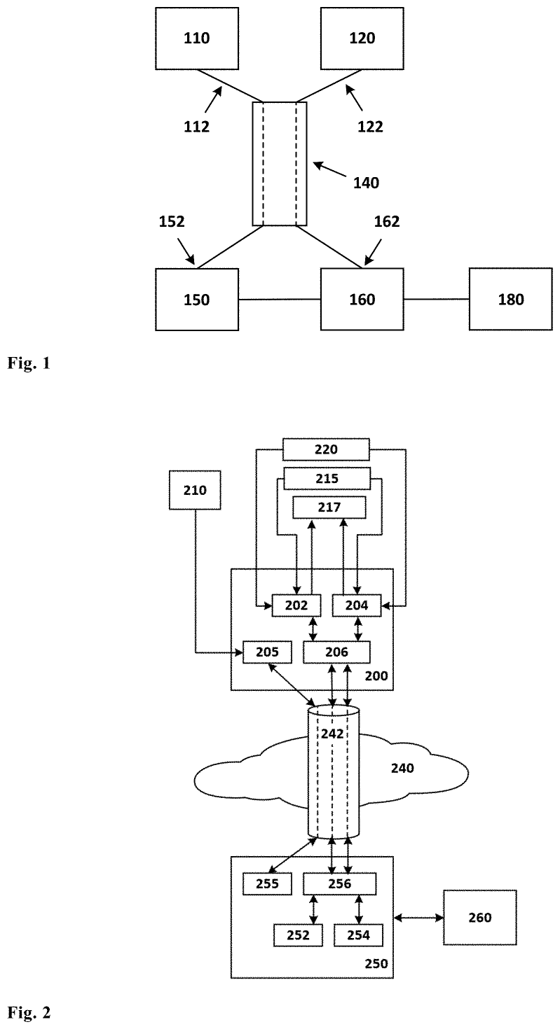

FIG. 1 is a schematic block diagram illustrating the different modules comprised in a solution described in applicant's own U.S. Pat. No. 10,063,552 B2. The present invention introduces an improvement of this solution.

FIG. 2 is a schematic block diagram illustrating a system according to the invention for operating a safety-critical device 260 enabled via a secure communication channel 242 of a non-secure network 240, and for providing reliable disengagement of operations of the safety-critical device 260. The safety critical device 260 may for instance be a weapon station (WS).

The system comprises a first control panel interface 200 and one or more operating connected input devices 210, 220 at a near location. The input devices may for instance be a weapon fire control device and a weapon movement control device. In the figure, input device 210 controls non-safety critical functions, while input device 220 controls safety-critical functions.

The system is adapted for transmitting control signals to the safety-critical device 260 at a remote location, the first control panel interface 200 comprises hardware barrier communication means 206 and at least a first and a second hardware safety barrier 202, 204, each with safety barrier interfaces. The figure illustrates an example where operating input device 220 in connected to the first and second hardware barriers 202, 204. The first and a second hardware safety barriers 202, 204 are further connected to the hardware barrier communication means 206 for safe communication through the non-secure network 240.

The first control panel interface 200 further comprises communication means 205 for transferring signals from input device 210 controlling non-safety critical function of the safety-critical device 260.

The non-secure communication network 240 may be a packet-based communication network, such as an Internet Protocol (IP) network.

The system further comprises a second control panel interface 250, connected to the safety-critical device 260 at the remote location, and which is adapted for receiving control signals from the first control panel interface 200. The second control panel interface 250 comprises hardware barrier communication means 256 and at least a first and a second hardware safety barrier 252, 254, each with safety barrier interfaces connected to the hardware barrier communication means 256 for communication through the non-secure network 240.

The second control panel interface 250 further comprises communication means 255 for transferring signals to and from input device 210 controlling non-safety critical function of the safety-critical device 260.

The system further comprises a switch 215, connected to the first and second hardware safety barriers 202, 204 of the first control panel interface 200, controlling Hi- and Lo-signal inputs on the hardware safety barriers, such that a Hi-signal is input on the first hardware safety barrier 202 and a Lo-signal is input on the second hardware safety barrier 204 and vice versa for respectively enabling and disengaging operation of the safety-critical device 260.

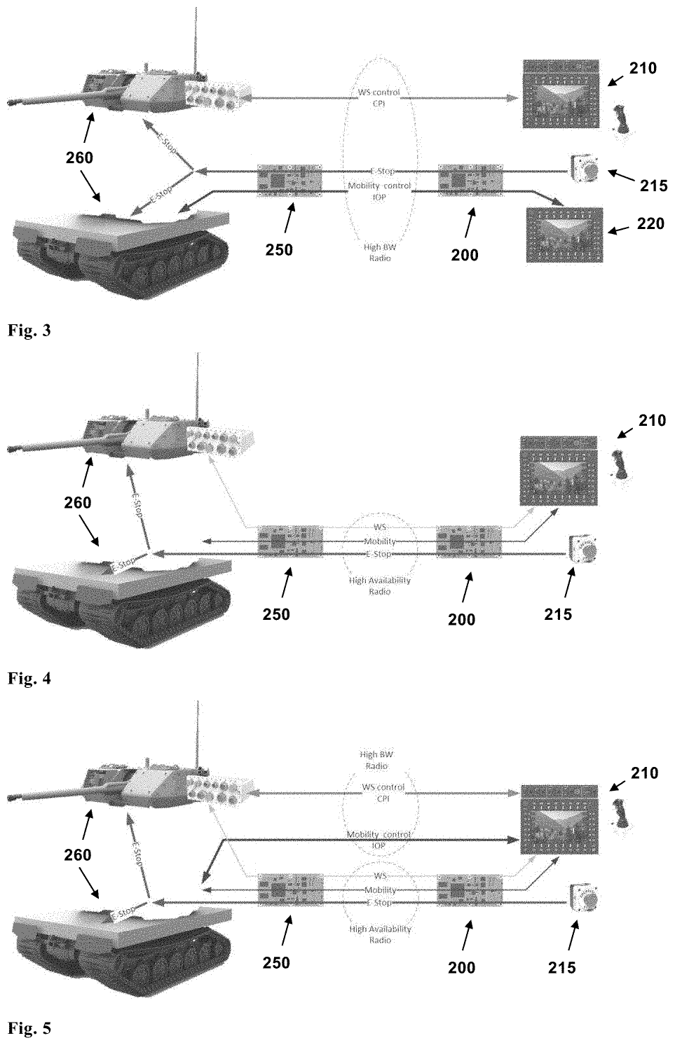

FIGS. 3 to 5 show several scenarios with different operational levels where the inventive solution can be used according to level autonomy of the device at the remote location. A remote weapon station (RWS) on a Robotic Controlled Vehicle (RCV) is used as an example, but other types of safety-critical devices can use the described solution.

The operational levels, i.e. levels of autonomy, where the invention can be applied, for a safety-critical device, such as for instance for the RWS and RCV, includes all levels 1 to 5 listed in the background section above.

The solution according to the present invention has two different setups, one for level 1 to 3, and one for all levels, i.e. 1 to 5.

Level 1 to 3 requires a high bandwidth radio for closed loop operator control, while level 4 and 5 does not require the same bandwidth and should make use of low bandwidth radios with high availability/range.

These levels are in line with the different levels described in the background section.

FIG. 3 illustrates a solution in line with operation level 1 to 3, with man-on-the-loop. The mobility operator and the lethality operator may be separated or operate from a common screen.

FIG. 4 illustrates a solution in line with operation level 4 and 5, with a man-on-the-loop and man-off-the-loop. This solution only requires a high availability radio. The system provides information to the operator for authorization to engage, mobility navigates only on waypoints/routes. Since the closed loop control of the operator is no longer required, the weapon station (WS) control and the Mobility control interface is not required. The remaining WS and mobility signaling interface is for controlling the boundaries of the autonomy functions on the WS and platform.

FIG. 5 illustrates a solution in line with operation level 1 to 5, man-in-the-loop, man-on-the-loop and man-off-the-loop. This solution requires both a high bandwidth radio and high availability radio. The system may be operated dynamically as man-in-the loop when the high bandwidth radio is available and as man-on/off-the loop when only the high availability radio is providing connectivity. This makes the solution very flexible.

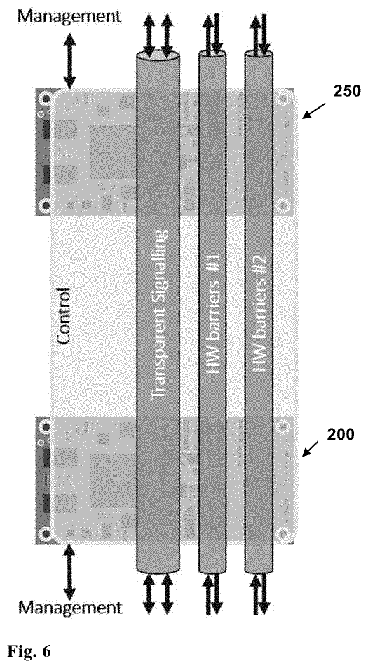

FIG. 6 illustrates interworking services between safety client and server. Here, the client is the first control panel interface 200, while the server is the second control panel interface 250 as described above. The solution is generalized to provide a management interface through which the client-server connectivity, operation and status is managed. The control function is the internal system maintenance function which provides Multi-Client, Multi-Server support, server auto-discovery, safe transfer of HW barriers and transparent Software (SW) signaling channels between the client and the server.

The transparent signaling channels may provide TOP signaling (Joint Architecture of Unmanned Systems, JAUS messages) for RCV/UGV mobility solutions or other protocols.

The solution according to the present invention has the following characteristics and advantages:
It provides a safe diverse transfer of HW barriers and operator indications over a network.
It is based on the safety principles of the safety approved CPI, ref. U.S. Pat. No. 10,063,552 B2.
It is authenticated (security approval through government agencies).
It is a general network-based architecture which can be supported on different radios.
It requires low bandwidth and will provide a deployable solution at level 1 to 5 described above.
The used HW can easily be tailored, will depend on signaling needs.
It is default safe—loss of connectivity implies disabled system.
It is TOP and CPI compatible.
It has a very low physical footprint
It is media agnostic (copper, fiber, radio)
It provides Multi-Client, Multi-Server support
It provides server auto-discovery
It provides a Probability of Failure per Hour (PFH) for dangerous failures for continuous operation above SIL 4.

The solution provides Multi-Client functionality. Through the client management interface illustrated in FIG. 6, the server to connect to is selected prior to requesting control. The client will through this become a member of a server arbitration group.

All clients in the server arbitration group can all arbitrate for connectivity to the server. The arbitration is fast (<100 msec), activated through io or signaling. The arbitration is based on priority of the allocated role of the client. The system can support many clients and servers in the same network.

The clients are initially, when joining the arbitration group, in the monitoring state. In this state the client is not connect and cannot send/receive on the signaling channels or HW barriers, i.e. all are safe. The client does however receive status information from the server, e.g. which client is connected to the server. If the client is granted connectivity it is in the connected state. In the connected state the signaling and barrier transfer services are provided.

The solution further provides Multi-Server functionality where the servers announce their presence in the network through standard protocols like SAP/SDP distributed in multicast groups. All clients in the network monitors the announcements and builds a list of available servers. The list of servers is made available on the management interface of the client.

The client will at power up belong to a default server but through the management interface of the client the server to connect to can be selected. One server can be connected to at most one client, and one client can be connected to one server.

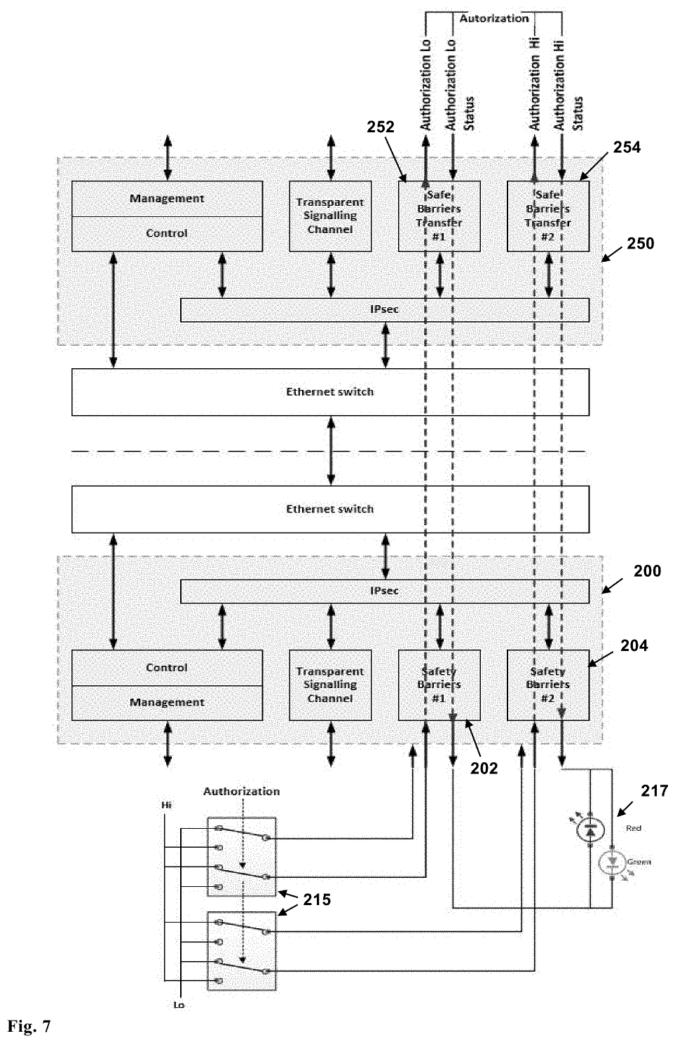

FIG. 7 illustrates the main interfaces of the solution and the implemented ATP (E-stop). The figure shows the interfaces and modules of the design. The safe barrier transfer is redundant to provide the possibility of 2 HW barriers and 1 SW barrier which is through the CPI control for each safety critical function. The input on the client is mirrored on to the output of the server and vice versa. This information is transferred through the barrier to barrier protocol from the CPI. The use of the design for ATP (E-stop) is also shown in the figure where the ATP (E-stop) switch uses 2 HW barriers to transfer the Hi- and Lo-signal side of the enable switch. Both must set correctly to enable the system.

According to one embodiment of the invention, the system for operating a safety-critical device 260 further comprising a light source 217 as illustrated in FIG. 7. The light source is preferable a multicolor LED, e.g. which can display red and green color. The light source 217 is connected to the first and the second hardware safety barriers 202, 204 of the first control panel interface 200 for indicating status of the safety-critical device 260. The different states of the light source are controlled by Hi- and Lo-signals, received from the second control panel interface 250, on the first and second hardware safety barriers 202, 204 of the first control panel interface 200.

The table below illustrates the different possible situations and corresponding light indications.

| Hi | Lo | ATP | | |
|---|---|---|---|---|
| side | side | Function | LED | Situation |
| Low | Low | Off (*) | Off | Error. Barriers equal: e.g. lack of |
| | | | | coms, failed diagnostics |
| High | Low | On | Green | System enabled |
| Low | High | Off (**) | Red | System disabled |
| High | High | Off (*) | Off | Error. Barriers equal: e.g. lack of |
| | | | | coms, failed diagnostics |

(*) no +ve voltage between Hi and Lo,
(**) −ve voltage between Hi and Lo.

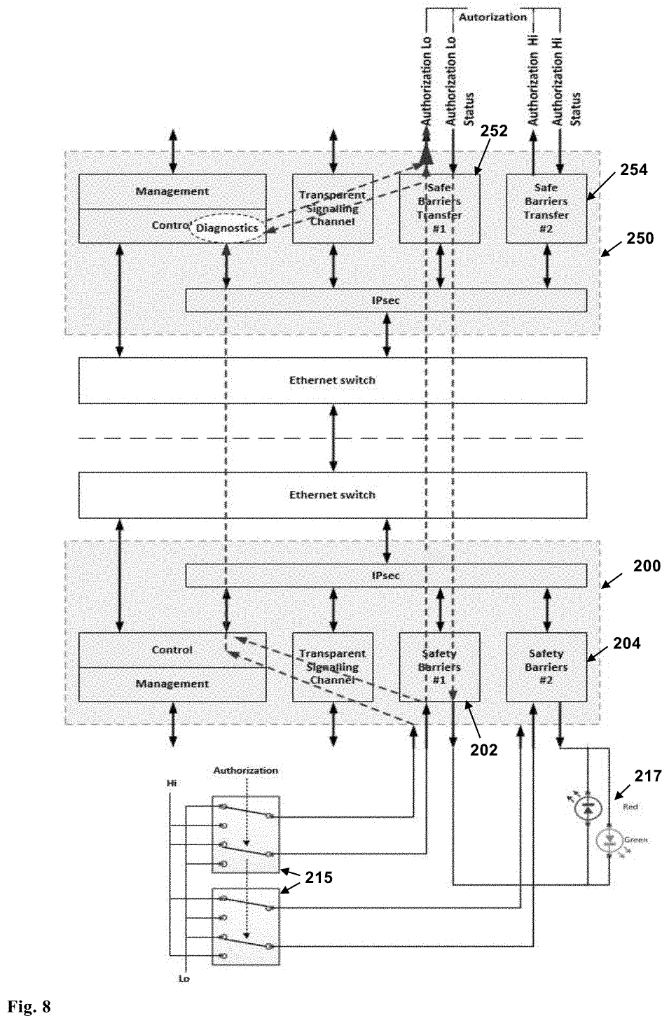

FIG. 8 illustrates the implemented ATP (E-stop) used with a diagnostic information path. The information transfer of the HW safety barriers may be provided with diagnostic information as indicated in the figure. The input from the switch 215 is provided with 2 switches on each hardware safety barrier 202, 204. The CPI control SW on the client reads the inputs and verifies that the inputs are inverted on both barriers (only one shown in figure).

The diagnostic information, i.e. the switch positions, is signaled to the server side, i.e. to the second control panel interface 250. The SW on the server side reads the state of the transferred information and verifies the correct state of the HW barrier. If a correspondence is verified, the signal is let through to the output.

The ATP switch 215 in this scenario uses two HW barriers to transfer the Hi- and LO-signal side of the ATP switch 215, and in addition each of the HW barriers has diagnostic signals to verify the correct information transfer where the diagnostic information is transferred on a third path.

The actual state of the server output, i.e. the second control panel interface 250, is then fed back as inputs on the server to provide the reverse path back to the operator for operator confirmation regarding the state of the ATP function. All the signals are multiplexed into an IPsec tunnel for an integrity verified transmission. This solution provides both diversity on multiple HW barriers and diagnostics on each barrier.

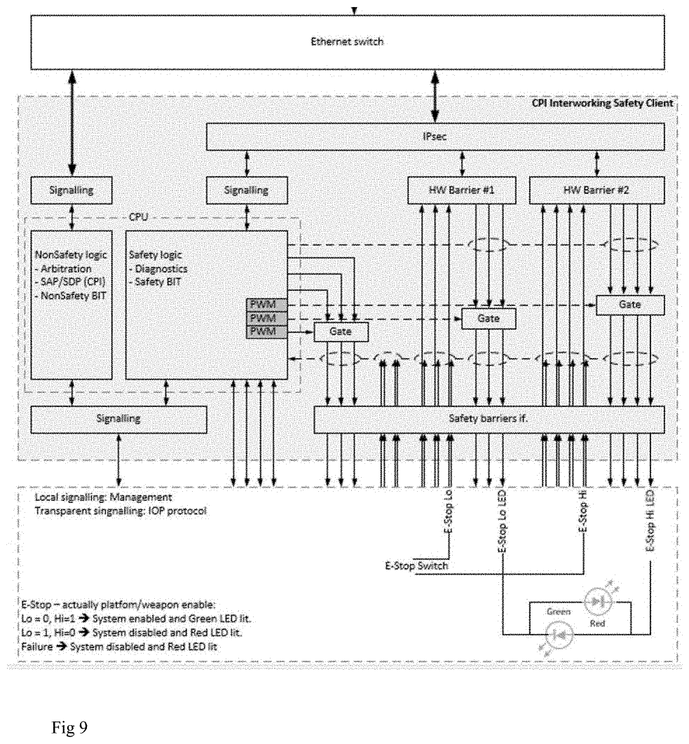

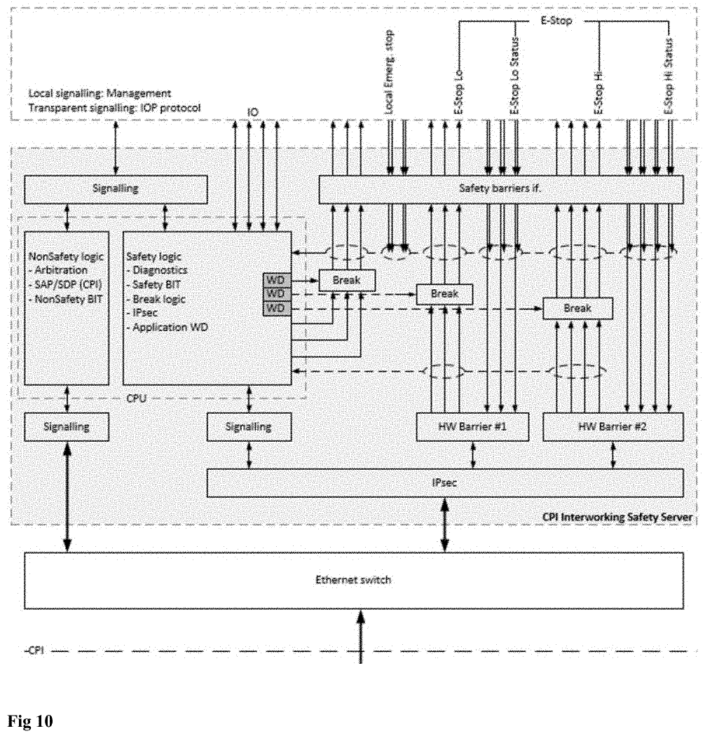

FIG. 9 shows a block diagram of the first control panel interface 200, operating as a client, and FIG. 10 shows block diagram of the second control panel interface 250, operating as a server. The design of the client and server boards are the same, but they are operated differently as is illustrated in the figures.

The server SW can support a local emergency stop as an addition to the ATP/E-Stop connected to the client and can further support multiple simultaneous barrier signals with diagnostics as shown.

The ATP function may be combined with transparent signaling channels as shown in Error! Reference source not found. FIG. 6. This enables a standard compliant solution for e.g. IOP based mobility where the IPsec tunnel is also part of the IOP standard. The additional HW barriers can be used for ATP/E-Stop but also to enhance the IOP solution with e.g. HW based mobility enable signals. This is useful in the manual mobility control scenarios where a Palm switch on the control grip needs to be activated. The Palm switch can be transferred on the HW barriers.

The current inventive solutions for ATP/E-stop over Ethernet/IP are based on solutions where a SW architecture is “made safe”. The SW is designed for high certified integrity levels, typically SIL3, IEC 61508 with safety protocols added on top of a standard transmission protocol set. Examples of this are:
Common Industrial Protocol (CIP) with the CIP Safety for Safety Services. This is a protocol set maintained and developed by, the Open DeviceNet Vendors Association (ODVA) and ControlNet international. The CIP Safety is based on an option called “the black channel”. The black channel assumes that network is completely unreliable, so diagnostics must exist outside of the network infrastructure, i.e. a separate SW safety protocol, the CIP Safety.
Converged Plantwide Ethernet (CPwE) refers to CIP Safety.
openSAFETY is a version of the CIP protocol, and is used to transmit information that is crucial for the safe operation of machinery in manufacturing lines, process plants, or similar industrial environments over different communication protocols, also Ethernet. This also based on “black channel” option. openSAFETY makes use of the option to establish connections via its own assemblies. Safe communication then proceeds via these assemblies. This is also a SIL3 SW implementation.
SIGMATEK E-Stop solutions are based on the PLCopen standard. This is also a black channel SW based E-stop solution.

All identified alternative solutions are based on SW developed with a formalized process and well-defined architecture to establish a safe solution. These types of solutions do not provide a verifiable diversity in the same way as the proposed solution. Neither do they provide the same level of safe operation, SIL 3 according to IEC 61508 shall provide a system probability of dangerous failure per hour (PFH) of 10⁻⁷-10⁻⁸. The proposed ATP/E-stop solution provides a PFH which is above SIL 4.

### ACRONYMS AND ABBREVIATIONS

### AI Artificial Intelligence

ATP Authorization to proceed

### CPI Control Panel Interface

### HMI Human Machine Interface

### TOP Unmanned Ground Vehicle (UGV) Interoperability Profile

### IP Internet Protocol

### JAUS Joint Architecture of Unmanned Systems

### RCV Robotic Combat Vehicle

### RPV Robotic Patrol Vehicle

### RWS Remote Weapon Station

### SAP/SDP Session Announcement Protocol/Session Description Protocol

### SIL Safety Integrity Level

### TA Target Acquisition

### TE Target Engagement

### UGV Unmanned Ground Vehicle

### USG United States Government

### USMC US Marine Core

### WS Weapon Station

### FIGURE REFERENCES

110—operating input device
112 —first barrier control signal
120—operating input device
122—second barrier control signal
140—communication network
150—first barrier circuit
152—first activating input
160—second barrier circuit
162—second activating input
180—safety critical device
200—first control panel interface
202—first hardware barrier
204—second hardware barrier
205—communication means
206—hardware barrier communication means
210—first input device
215—switch
217—light source
220—second input device
240—non-secure network
242—secure communication tunnel
250—second control panel interface
252—first hardware barrier
254—second hardware barrier
255—communication means
256—hardware barrier communication means
260—safety critical device

1. A system for operating a safety-critical device via a non-secure network, and for providing reliable disengagement of operations of the safety-critical device, comprising:
a first control panel interface, at a near location, adapted for transmitting control signals to the safety-critical device at a remote location, the first control panel interface comprises hardware barrier communication means and at least a first and a second hardware safety barrier, each with safety barrier interfaces connected to at least one operating input device and to the communication means for communication through the non-secure network,
a second control panel interface, connected to the safety-critical device, adapted for receiving control signals from the first control panel interface via a secure communication tunnel, the second control panel interface comprises hardware barrier communication means and at least a first and a second hardware safety barrier, each with safety barrier interfaces connected to the hardware barrier communication means for communication through the non-secure network, were the safety-critical device is activated when both hardware barriers are activated,
wherein the system further comprises:
a switch, connected to the first and second hardware safety barriers of the first control panel interface, controlling Hi- and Lo-signal inputs on the hardware safety barriers, such that a Hi-signal is input on the first hardware safety barrier and a Lo-signal is input on the second hardware safety barrier and vice versa for respectively enabling and disengaging operation of the safety-critical device.

2. The system according to claim 1, further comprising a light source connected to the first and the second hardware safety barriers of the first control panel interface for indicating status of the safety-critical device.

3. The system according to claim 2, where the first and second control panel interfaces further comprises respective communication means and software safety barrier providing transparent signaling between the first and second control panels interfaces.

4. The system according to claim 1, where the first and second control panels interfaces comprise identical hardware, where the first control panel interface is operated as a client, while the second control panel interface is operated as a server.

5. The system according to claim 1, configured to return to a default safe state by disabling the safety-critical device when communication between the first and second control panel interfaces is lost.

6. The system according to claim 1, for operating, at a near location, a plurality of safety-critical devices each connected to a second panel control interface located at the remote location, the first control panel interface comprises:
a first multiplexer, multiplexing a plurality of first barrier control signals onto the secure communication tunnel through the non-secure communication network;
a second multiplexer, multiplexing a plurality of second barrier control signals onto the secure communication tunnel through the non-secure communication network;
each second panel control interface connected to each safety critical device comprises a first demultiplexer, demultiplexing the first barrier control signals, and a second demultiplexer, demultiplexing the second barrier control signals.

7. System according claim 1, wherein the non-secure communication network is a packet-based communication network.

8. System according to claim 1, wherein the non-secure communication network is an Internet Protocol (IP) network and the secure communication tunnel is an Internet Security (IPsec) network tunnel configured in an integrity only mode.

9. System according to claim 1, wherein the communication through the secure communication tunnel employs a protocol which includes timestamping of data.

10. System according to claim 3, wherein the safety-critical device includes at least one of a weapon firing circuitry, a weapon movement circuitry, and a video confirmation device.

11. System according to one of the claims 1-9, wherein the one or more operating input devices includes at least one of:
a weapon fire control device, a weapon movement control device, and a video session information device.

12. System according to claim 1, wherein the operating input device includes a video session information device, and the safety-critical device includes a video confirmation device, the system further comprising:
a video distribution device providing a video signal, the video signal being transferred through the non-secure communication network and displayed on a screen at the near location;
the video session information device being configured to derive video session information from the video signal and transfer the video session information through the secure communication tunnel,
the video confirmation device being configured to confirm the authenticity of the video signal transferred through the non-secure communication network.

13. A method for operating a safety-critical device via a non-secure network, and for providing reliable disengagement of operations of the device, comprising:
providing, at a near location, a first control panel interface for transmitting control signals the safety-critical device at a remote location, the first control panel interface comprises hardware barrier communication means and at least a first and a second hardware safety barrier, each with safety barrier interfaces connected to at least one operating input device and to the hardware barrier communication means for communicating through the non-secure network,
providing, at the remote location and connected to the safety-critical device, a second control panel interface adapted for receiving control signals from the first control panel interface via a secure communication tunnel, the second control panel interface comprises hardware barrier communication means and at least a first and a second hardware safety barrier, each with safety barrier interfaces connected to the hardware barrier communication means for communication through the non-secure network,
establishing communication between the first and second control panel interfaces via said first and second hardware safety barriers and the communication means of the first and second control panel interfaces,
connecting a switch to the safety barrier interfaces of the first and second hardware safety barriers of the first control panel interface and transmitting a Hi-signal on the first hardware safety barrier and a Lo-signal on the second hardware safety barrier when the state of the switch is enabled, and transmitting a Lo-signal on the first hardware safety barrier and a Hi-signal on the second hardware safety barrier when the state of the switch is disabled,
activating the safety-critical device when both hardware barriers of the second control panel interface are activated and the switch connected to the first control panel interface is enabled,
continuously monitoring the Hi- and Lo-signals received on the first and second hardware safety barriers of the second control panel interface, and continuously returning the received Hi- and Lo-signals to the first control panel interface via the first and second hardware safety barriers of the second control panel interface,
disengaging the safety-critical device if the switch is in a disabled state.

14. The method according to claim 13, by connecting a light source to the first and the second hardware safety barriers of the first control panel interface for indicating status of the safety-critical device.

15. The method according to claim 13 or 14, further comprising continuously signaling the state of the switch from the first control panel interface to the second control panel interface and verifying that the state corresponds to the Hi- and Lo-signals received on the second hardware safety barriers of the second control panel interface.

16. The method according to claim 13, further comprising providing a software safety barrier with transparent signaling to and from the first and second control panels interfaces.

17. The method according to claim 13 or 14, by disabling the safety-critical device when communication between the first and second control panel interfaces is lost, thereby returning to a default safe state.

18. The method according to claim 13, for operating, at a near location, a plurality of safety-critical devices located at the remote location, the method further comprising:
multiplexing, on the first panel interface, a plurality of first barrier control signals onto the secure communication tunnel through the non-secure communication network,
multiplexing, on the first panel interface, a plurality of second barrier control signals onto the secure communication tunnel through the non-secure communication network;
demultiplexing the first and second barrier control signals, received from the first panel interface, on each second panel control interface connected to each safety critical device.

19. The method according to claim 13, wherein the non-secure communication network is a packet-based communication network.

20. The method according to claim 17, wherein the non-secure communication network is an Internet Protocol (IP) network, and the secure communication tunnel is an Internet Security (IPsec) tunnel and configured in an integrity only mode.

21. The method according to claim 17, wherein the communication through the secure communication tunnel employs a protocol which includes timestamping of data.

22. The method according to claim 13, wherein the safety-critical device includes at least one of a weapon firing circuitry, a weapon movement circuitry, and a video confirmation device.

23. The method according to claim 13, wherein the at least one operating input device includes at least one of:
a weapon fire control device, a weapon movement control device, and a video session information device.

24. The method according to claim 13, wherein at least one of the first and second operating input devices include a video session information device, wherein the safety-critical device includes a video confirmation device, and the method further comprises:
generating, by a video distribution device, a video signal,
transmitting the video signal through the non-secure communication network,
receiving the video signal at a screen at the near location and displaying content of the video signal thereon,
deriving, by the video session information device, video session information from the received video signal,
transmitting the video session information through a secure communication tunnel to the video confirmation device, and
confirming, at the video confirmation device, an authenticity of the video signal.
